(19) United States
(12) Patent Application Publication
(10) Pub. No.: US 2010/0043173 A1
(43) Pub. Date: Feb. 25, 2010

(54) ADJUSTABLE UPSTOP FOR FRAMELESS AUTOMOTIVE DOOR

(76) Inventors: Geoffrey Barr, Troy, MI (US); Kristopher M. Flowers, Troy, MI (US)

Correspondence Address: CANTOR COLBURN, LLP, 20 Church Street, 22nd Floor, Hartford, CT, 06103, US

(21) Appl. No.: 12/544,872

(22) Filed: Aug. 20, 2009

Related U.S. Application Data
(60) Provisional application No. 61/090,482, filed on Aug. 20, 2008.

(51) Int. Cl. E05F 5/06

(52) U.S. Cl. 16/82

(57) ABSTRACT

A guide block for a window in a frameless vehicle door, the guide block, comprising: a main body portion having a collet received within a cavity of the main body portion; a spring disposed between the collet and an inner surface of the cavity; and a threaded screw received within the collet and the spring wherein the spring acts against the collet to allow the screw to threadingly engage the collet and the opens and allows the threaded screw to slide within the collet.

### CROSS REFERENCE TO RELATED APPLICATIONS

This application claims the benefit of the following U.S. Provisional Patent Application Ser. No. 61/090,482 filed Aug. 20, 2008, the contents of which are incorporated herein by reference thereto.

### BACKGROUND

Exemplary embodiments of the present invention relate to adjustable up stops for windows in vehicles.

Adjustable up stops are a necessity when implementing a window regulator in a vehicle frameless door, providing a limit to the glass travel and being adjustable to allow for build and vehicle variations. Typical up stops require multiple parts that are costly from a parts and installation view point.

Glass adjustment is also necessary when implementing a window regulator in a vehicle frameless door, providing alignment to the upper seal/roof and to the pillars. This has been achieved in the past by manually moving the glass into position whilst clamping the glass in position in the window regulator. This method is hit and miss and can be time consuming.

Accordingly, it is desirable to provide an adjustable up stop that is easy to install and has a minimal amount of parts.

### SUMMARY OF THE INVENTION

In one embodiment a guide block for a window in a frameless vehicle door is provided, the guide block, comprising: a main body portion having a collet received within a cavity of the main body portion; a spring disposed between the collet and an inner surface of the cavity; and a threaded screw received within the collet and the spring wherein the spring acts against the collet to allow the screw to threadingly engage the collet and the collet opens and allows the threaded screw to slide within the collet.

In another exemplary embodiment, a guide block for a window in a frameless vehicle door is provided, the guide block having: a main body portion having a collet received within a cavity of the main body portion; a spring disposed between the collet and an inner surface of the cavity; and a threaded screw received within the collet and the spring wherein the spring acts against the collet to allow the screw to threadingly engage the collet when the collet is in a closed position and wherein the collet is configured to open in the cavity from the closed position to an open position to allow the threaded screw slide within the collet when it is in the open position.

### BRIEF DESCRIPTION OF THE DRAWINGS

Other features, advantages and details appear, by way of example only, in the following description of embodiments, the description referring to the drawings in which:

FIGS. 1-5 illustrate exemplary embodiments of a guide block constructed in accordance with an exemplary embodiment of the present invention.

### DETAILED DESCRIPTION

Exemplary embodiments of the present invention are directed to a guide block with an adjustable stop and/or a guide block that provides a means for providing a spring loaded glass adjustment of a vehicle door. Accordingly, exemplary embodiments of the present invention seeks to simplify and reduce the assembly time and reduce the financial cost related to window adjustments.

Exemplary embodiments of the present invention will reduce the assembly time and increase the accuracy of adjustment, resulting in improved sealing and wind noise performance of the vehicle with less reworks.

In one exemplary embodiment, the present invention reduces piece cost and reduces the total part count to a single guide block thus eliminating the die casting and machining steps by molding the retainer as a one piece open collet with molded-in threads. In addition and in one exemplary embodiment, the guide block is also made out of an easily molded material such as plastic or equivalent thereof Thus, this construction will reduce piece cost and make for easier assembly.

In one embodiment, the assembly works by having the screw pre-assembled in the lowered position. Then the glass is raised to a gauge block in the assembly fixture, at which time the screw is physically lifted until the bumper contacts the gauge block. The upward movement of the screw unloads the wedge and opens the collet and allows the screw to ratchet up to the block while the collet is held down by spring pressure into its housing.

The upward force of the regulator in normal operation is reacted by the threaded screw being clamped by the collet due to the wedging action of the collet in its housing.

Another embodiment of the present invention reduces assembly time by allowing the glass to be lifted into position by the regulator to front and rear fixture upstop gauge set blocks, whilst manually sliding the glass rearward to a fore aft set block. The glass is presented by an exemplary embodiment of the invention with the front of the glass tilted upwards by means of a spring feature in the front regulator sliding guide block.

The glass will initially contact the front upper stop and rotate about this point until the entire upper edge of glass is aligned. At this point the regulator upstops are adjusted, and the glass clamped in position.

The glass movement is facilitated by oversized holes in the glass allowing for the glass nose up starting position. The rear of the glass is directly lifted by a feature in the rear regulator sliding guide block.

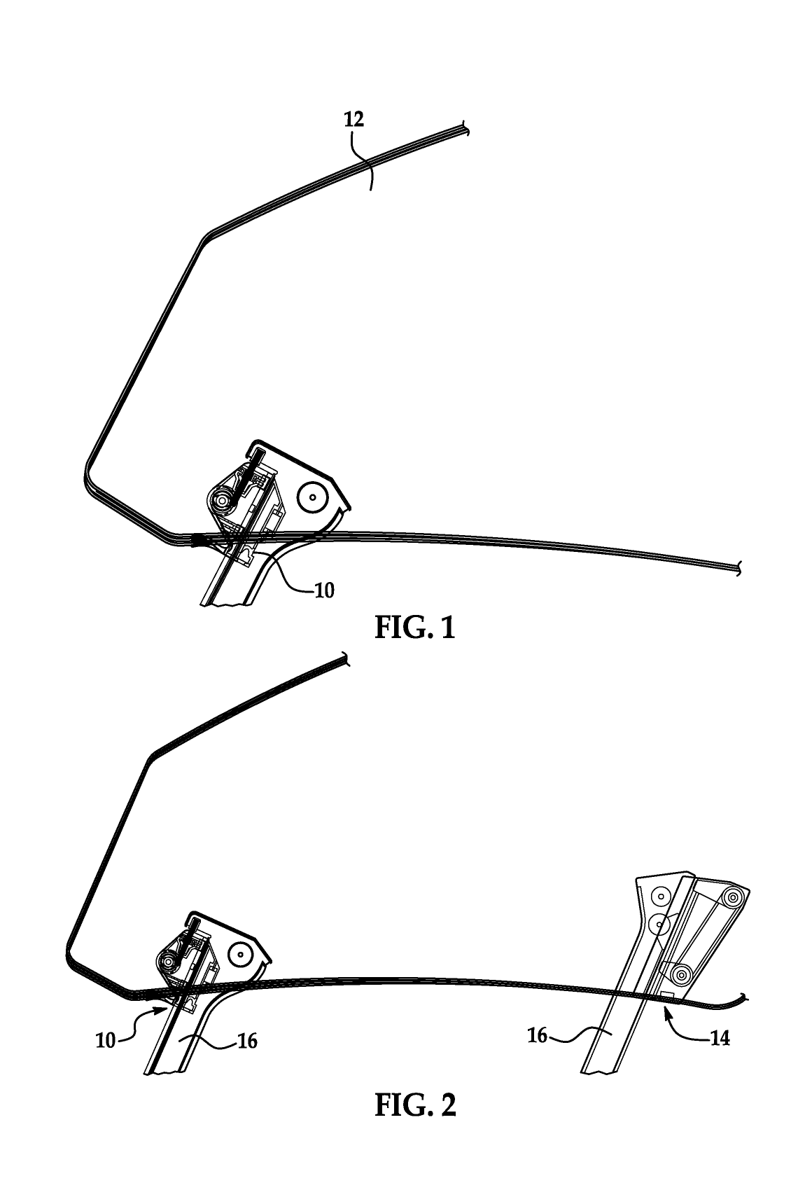

Referring now to FIGS. 1-5 a guide block 10 in accordance with an exemplary embodiment of the present invention is illustrated. Here, guide block 10 provides an adjustable up stop for a frameless automotive door regulator. In addition, the guide block also provides for spring-loaded glass adjustment to the glass installed in the frameless door. As illustrated, the window glass 12 is moved up and down by having guide block 10 in a rearward guide block 14 slightly received within a pair of guide rails 16.

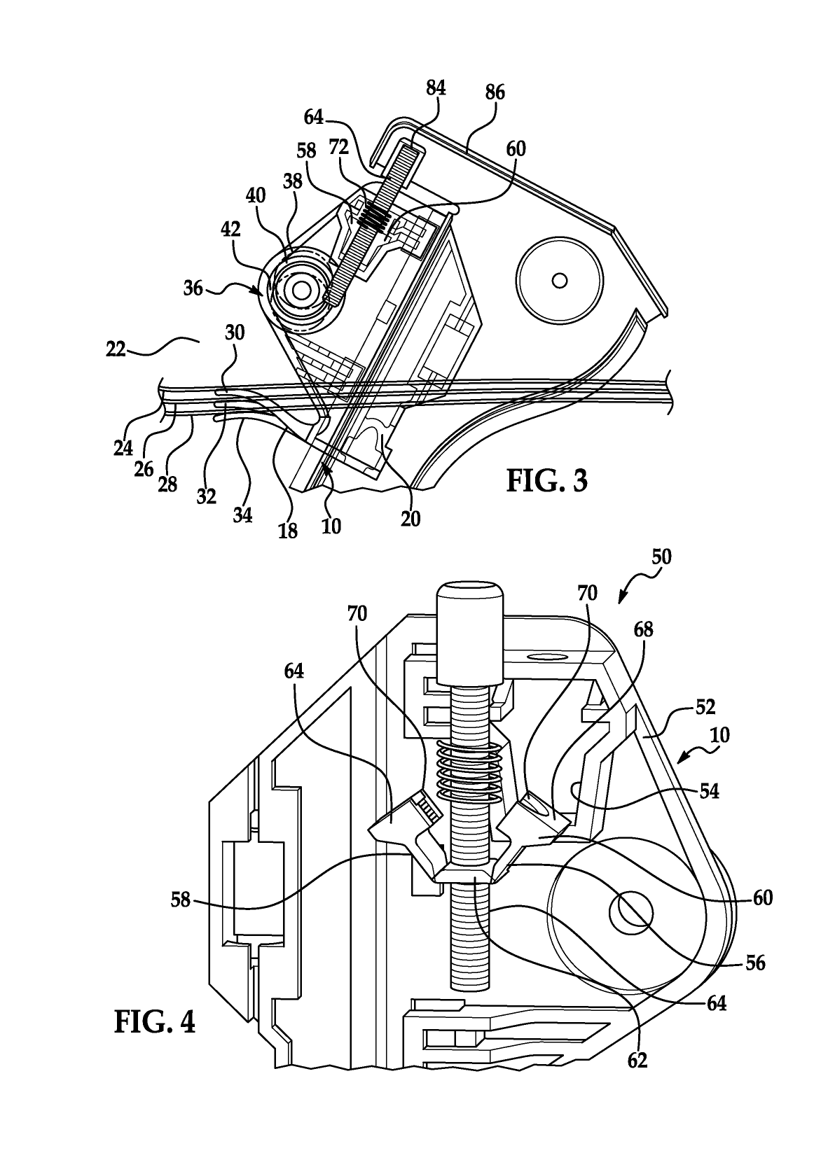

As illustrated in FIG. 3 guide block 10 has a resilient spring feature 18 that depends away from the main body portion 20 of the guide block. As illustrated in FIG. 3 deflection of a forward portion 22 of window 12 is illustrated by the three lines 24, 26 and 28 while movement of the resilient spring member in conjunction with the forward portion of the window is illustrated by lines 30, 32 and 34. In addition, movement of a securement opening 36 in the forward portion of the window is illustrated by lines 38, 40 and 42.

This exemplary embodiment reduces assembly time by allowing the forward portion of the glass being tilted upwards by means of the spring feature in the front regulator sliding guide block wherein the glass will initially contact the front up or stop and rotate about this point until the upper edge of the glass is aligned, at this point two regulator up stops are adjusted and the glass is clamped into position. As discussed above movement of the glass is facilitated by oversized holes in the glass allowing for the glass to nose up.

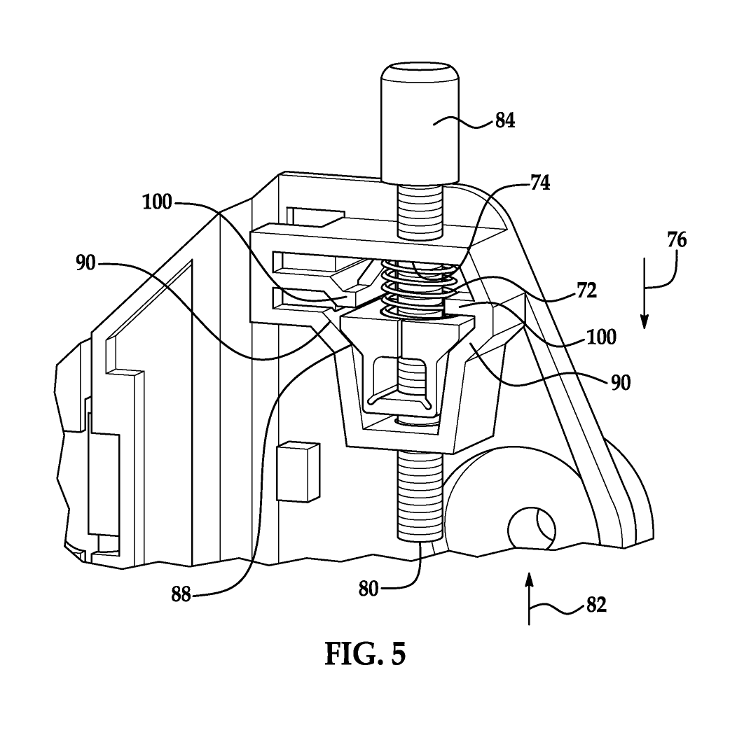

Another feature of an exemplary embodiment of the present invention is an adjustable up stop 50. Adjustable up stop 50 is provided in the guide block 10, which may or may not have the resilient spring feature as illustrated in at least FIG. 1. As illustrated, the guide block has a main body portion 52 with a cavity portion 54. Cavity portion 54 is configured to receive an open collet or engagement member 56. Collet 56 has a pair of side members 58 and 60 which move from an open position in FIG. 4 to a closed position in FIG. 5 when the collet is inserted into the cavity 54 of the main body portion 52. Also illustrated is that the side members 58 and 60 are pivotally secured to a base portion 62 having an opening (not shown) that may be threaded or unthreaded for receipt of a threaded screw 64 therein. In addition, each of the side members 58 and 60 will have an upper portion 64, 68 each defining a portion of an opening 70 that is configured to be disposed about the threaded screw when the collet is inserted into the opening. In one embodiment, the portions of the upper portion 64 and 68 defining opening 70 are threaded to engage threads of threaded screw 64 when the collet is closed around the shaft of the threaded screw. In addition and when the collet is installed in the cavity of the guide block the side members are pushed together and a spring 72 is disposed between upper portions 64, 68 and an inner surface 74 of the cavity. Spring 72 provides a biasing force in the direction of arrows 76 such that when the threaded screw spring and collet are installed in the cavity the threaded screw can be rotated and move upwardly or downwardly as the same is rotated.

However, and in accordance with an exemplary embodiment of the present invention and in order to provide an adjustable feature of the guide block and when a force is applied to a bottom portion 80 of the threaded screw sufficient to overcome the biasing force of the spring in the direction of arrow 76 the collet will open and the threaded screw will be capable of movement upward in the direction of arrow 82 such that a rubber grommet 84 disposed on an upper portion of the threaded screw moves from a non-contact position to a contact position with a stop member 86 (FIG. 3) such that the guide block is now provided with a properly adjusted stop. One contemplated embodiment is that of a frameless automotive door wherein stop member 86 limits the upward travel of the window glass. Thereafter, normal operation of the window is provided wherein movement of the window upward will continue until the rubber grommet makes contact with stop 86. Also shown is that portions of an inner wall 88 of the cavity are configured to have chamfered surfaces 90 positioned to aligned with complimentary angled surfaces of the sides of the collet. In one embodiment, the assembly consists of a bumper, a screw, a spring and a molded open acetal retainer collet.

Moreover, the force of the spring in the direction of arrow 76 causes the chamfered surfaces of the receiving area to engage complementary angled surfaces of the collet thereby pushing the side members 58 and 60 towards each other thus retaining the threaded member in the desired location when the guide block is moved upwardly in a guide track and the rubber grommet 84 contacts a stop member 86 wherein a downward force from the contact of the stop member on the grommet is also applied in the direction of arrow 76. Thus, the threaded portion is only adjustable upward in a direction opposite of arrow 76 when a force is applied to end 80 of the threaded portion sufficient to overcome the biasing force of the spring 72 and as long as there is room for movement of rubber grommet 84 between a stop member 86.

In addition, a pair of stops of side wall members 100 depend away from the wall defining cavity 54. Stops or side wall members provide an upward limit for the movement of the side members 58 and 60 so that lateral movement away from each other is limited and thus the opening between members 58 and 60 is prevented from becoming large enough to allow spring 72 to be received therein when an upward force is applied to end 80 sufficient to overcome the biasing force of spring 72 in the direction of arrow 76. If the spring were to be received within the opening defined by 58 and 60 it could possibly prevent them from moving back together again as the collet moves downwardly in the cavity.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A guide block for a window in a frameless vehicle door, the guide block, comprising:
a resilient spring member depending away from a main body portion of the guide block, the resilient spring member being configured to engage a portion of the window.

2. The guide block as in claim 1, wherein the main body portion further comprises:
a collet received within a cavity of the main body portion;
a spring disposed between the collet and an inner surface of the cavity; and
a threaded screw received within the collet and the spring, wherein the spring acts against the collet to allow the screw to threadingly engage the collet when the collet is in a closed position and the wherein collet is configured to open in the cavity to an open position and allow the threaded screw to slide within the collet when it is in the open position.

3. The guide block as in claim 2, wherein the cavity further comprises angled surfaces for mating with complimentary angled surfaces of the collet.

4. The guide block as in claim 3, wherein the cavity further comprises a pair of stop members for limiting movement of the collet in the cavity.

5. The guide block as in claim 2, wherein the threaded screw further comprises a rubber grommet for contacting a stop member.

6. The guide block as in claim 2, wherein the cavity further comprises a pair of stop members for limiting movement of the collet in the cavity.

7. The guide block as in claim 2, wherein the collet further comprises a pair of side members pivotally secured to a base portion having an opening for receiving the threaded screw therein, the side members being capable of moving from an open position that defines the open position of the collet to a closed position that defines the closed position of the collet and wherein each of the pair of side members define an opening for receiving the threaded screw therein.

8. The guide block as in claim 7, wherein each of the pair of side members has a threaded portion for defining a portion of the opening defined by the pair of side members and the threaded portion engages the threaded screw when the pair of side members are in the closed position.

9. The guide block as in claim 8, wherein each of the pair of side members has an angled surface for engaging a complimentary angled surface in the cavity.

10. The guide block as in claim 7, wherein each of the pair of side members has an angled surface for engaging a complimentary angled surface in the cavity, wherein engagement of the angled surfaces of the pair of side members along the angled surfaces in the cavity cause the collet to move from the open position to the closed position.

11. A guide block for a window in a frameless vehicle door, the guide block, comprising:
a main body portion having a collet received within a cavity of the main body portion;
a spring disposed between the collet and an inner surface of the cavity; and
a threaded screw received within the collet and the spring wherein the spring acts against the collet to allow the screw to threadingly engage the collet when the collet is in a closed position and wherein the collet is configured to open in the cavity from the closed position to an open position to allow the threaded screw slide within the collet when it is in the open position.

12. The guide block as in claim 11, wherein the cavity further comprises angled surfaces for mating with complimentary angled surfaces of the collet.

13. The guide block as in claim 11, wherein the cavity further comprises a pair of stop members for limiting movement of the collet in the cavity.

14. The guide block as in claim 13, wherein the threaded screw further comprises a rubber grommet for at one end for contacting a stop member.

15. The guide block as in claim 13, wherein the cavity further comprises angled surfaces for mating with complimentary angled surfaces of the collet.

16. The guide block as in claim 11, wherein the collet further comprises a pair of side members pivotally secured to a base portion having an opening for receiving the threaded screw therein, the side members being capable of moving from an open position that defines the open position of the collet to a closed position that defines the closed position of the collet and wherein each of the pair of side members define an opening for receiving the threaded screw therein.

17. The guide block as in claim 18, wherein each of the pair of side members has a threaded portion for defining a portion of the opening defined by the pair of side members and the threaded portion engaging the threaded screw when the pair of side members are in the closed position.

18. The guide block as in claim 19, wherein each of the pair of side members has an angled surface for engaging a complimentary angled surface in the cavity, wherein engagement of the angled surfaces of the pair of side members along the angled surfaces in the cavity cause the collet to move from the open position to the closed position.
